(19) United States
(12) Patent Application Publication
(10) Pub. No.: US 2005/0252393 A1
(43) Pub. Date: Nov. 17, 2005

(54) BASE FOR A SCREEN PRINTING MACHINE

(75) Inventor: Otto Richard Eppinger, Braeside (AU)

Correspondence Address: CONNOLLY BOVE LODGE & HUTZ LLP, SUITE 800, 1990 M STREET NW, WASHINGTON, DC, 20036-3425, US

(73) Assignee: REEFDALE PTY LTD, Braeside (AU)

(21) Appl. No.: 10/908,492

(22) Filed: May 13, 2005

(30) Foreign Application Priority Data
May 17, 2004 (AU) 2004902592

(51) Int. Cl. B41F 15/10

(52) U.S. Cl. 101/115

(57) ABSTRACT

A carousel screen printing machine which includes a stationary frame supporting a plurality of print heads, a rotatable central column supporting a plurality of pallet support arms and a base for the rotatable column consisting of two base frame members joined at one end and extending away from each other at an acute angle and cross members extending between said base frame members. An elevated platform above the base frame is supported by a member extending from the junction of the base frame members and from adjacent the free ends of the base frame members. A stator support is located on at least one cross member and arranged so that the column extends through the elevated platform. At least part of the drive means for the rotatable column is located below the support platform.

### BACKGROUND TO THE INVENTION

This invention relates to a base for carousel screen printing machines particularly of the kind used to screen print garments.

Carousel Screen printing machines are used for screen printing of garments and utilise a plurality of fixed print heads beneath which are positioned a plurality of garment support pallets which are moveable from one print head to the next. The pallet arms radiate out from a central column which forms a rotor that rotates the pallets from one printhead to the next in a serial indexing fashion. The pallet arms are raised toward the printheads for the printing operation and are lowered for rotation to the next print head.

U.S. Pat. No. 4,934,263 discloses a screen printer of this type where pneumatic cylinders are used to drive the rotation and lift the rotatable column.

U.S. Pat. No. 6,408,751 discloses a screen printer in which an electric motor drives a single ball screw lifting mechanism. In these patents and in other screen printing machine patents such as U.S. Pat. No. 5,626,074 or 5,189,950 the base is shown as rectangular usually with 4 peripheral frame members and associated cross members. These base frames are expensive in terms of material use and fabrication labour costs.

It is an object of this invention to provide a simple and cost effective base for screen printing machines.

### BRIEF DESCRIPTION OF THE INVENTION

To this end the present invention provides a carousel screen printing machine which includes
a) a stator supporting a plurality of print heads
a rotor supporting a plurality of pallet support arms
said rotor being mounted for rotation about said stator
drive means for said rotor
e) a base for said stator consisting of
i) base frame members secured together to form a first platform
ii) the first platform having 3 support feet
iii) an elevated platform supported by frame members mounted on said first
platform
iv) the stator being mounted on a frame member in the first platform and
extending vertically through the elevated platform
v) the rotor being mounted on said elevated platform
vi) at least part of the drive means being located on said first platform.

This arrangement provides a base of increased height and rigidity while using less material and lower cost fabrication steps. The base functions as a beam and adjustable feet may be fitted at the junction and free ends of the two base frame members. Preferably the frame members are box tube steel of square or rectangular cross sections. The added height of the base member does not increase the operational height of the carousel screen printer because the drive means, either electrical or pneumatic, can be accommodated in the space created between the first and elevated platforms.

In another aspect the present invention provides a carousel screen printing machine which includes
a) a stationary column supporting a plurality of print heads
a rotatable carousel mounted on said column supporting a plurality of pallet support arms
drive means for indexed movement of said carousel about said stationary column
d) a base for said column consisting of
two base frame members joined at one end and extending away from each other at an acute angle
cross members extending between said base frame members
an elevated platform supported by a member extending from the junction of the base frame members and from adjacent the free ends of the base frame members
a stationary column support located on at least one cross member and arranged so that the column extends through the elevated platform
at least part of the drive means for the rotatable column being located below the elevated platform.

The drive means may be electric or pneumatic as is usual with carousel garment screen printers.

### DETAILED DESCRIPTION OF THE INVENTION

A preferred embodiment of the invention will be described with reference to the drawings in which:

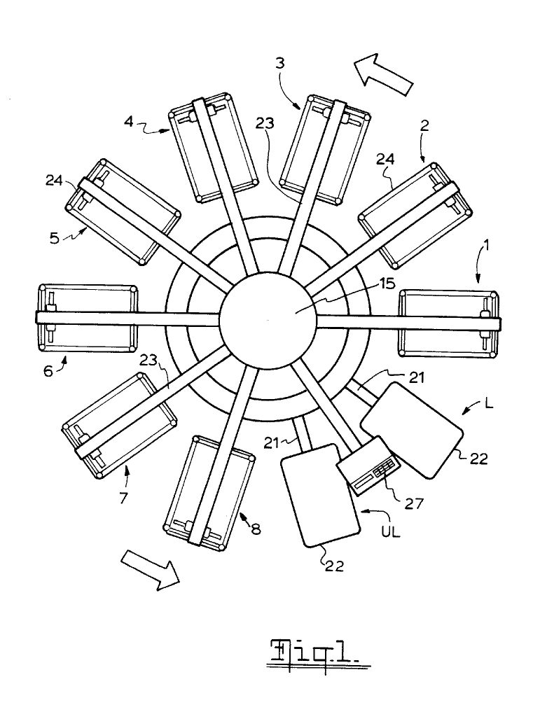

FIG. 1 is a schematic plan view of a conventional garment screen printing machine which can be operated according to the process of the present invention;

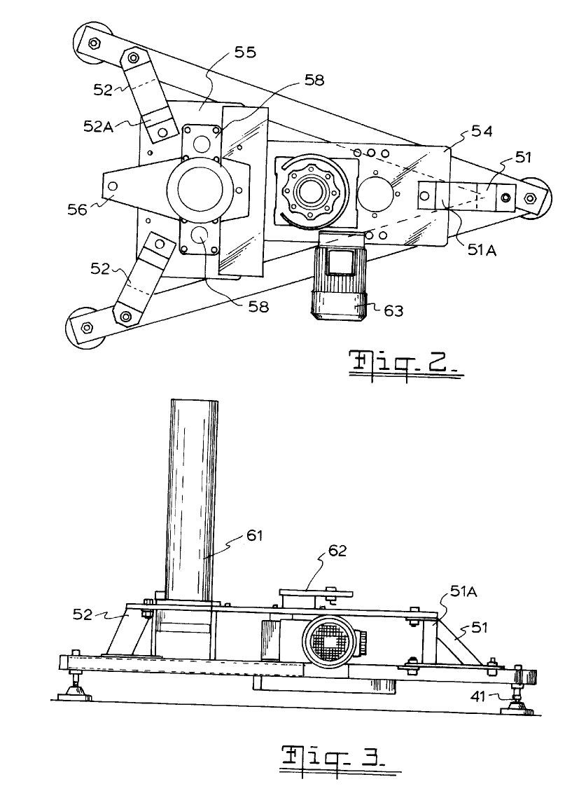

FIG. 2 is a plan view of a first embodiment showing the base of an electric screen printing machine;

FIG. 3 is a side elevation of the base of FIG. 2;

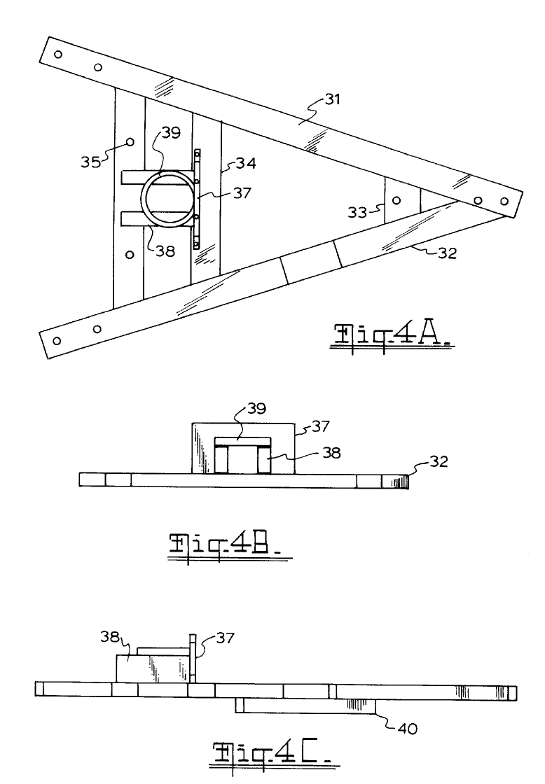

FIG. 4 A is plan view, 4B is an end view and 4C is a side view of the base frame of FIG. 2;

FIG. 5 is a plan view of a second embodiment showing the base of a pneumatic screen printing machine;

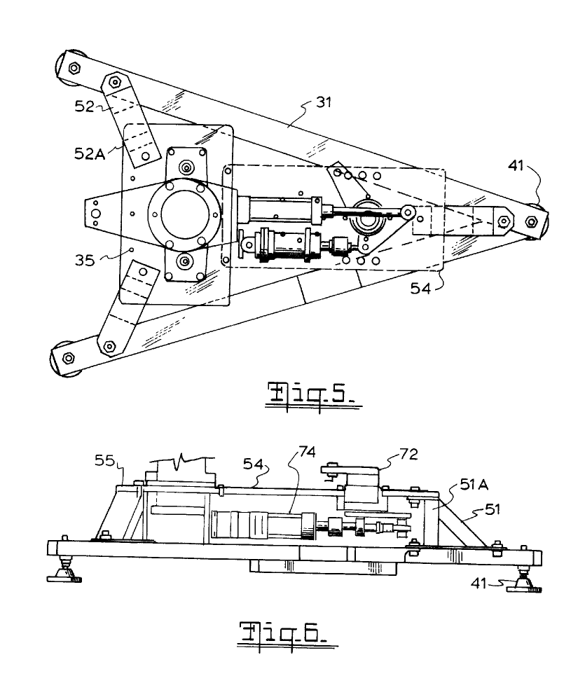

FIG. 6 is a side elevation of the base of FIG. 5;

In the machine illustrated the pallets rotate in an anticlockwise fashion but it is equally possible for the machine to function with clockwise rotation of the pallets.

The screen printing machine comprises a rotatable set of ten pallet arms 21 which are mounted for rotation about a central column 15. Each pallet arm 21 carries a garment pallet 22. Garments are fitted onto the pallets.

Above the pallets are a set of eight print heads 24 mounted on fixed printhead support arms 23 which also radiate from the central column 15. The print heads are numbered from 1 to 8 and the load station L and the unload station UL are located between printheads 1 and 8. The pallet arms 21 rotate in an anticlockwise direction as shown by the arrow. Each rotation is indexed so that each pallet moves sequentially from one station to the next.

The base according to this invention is illustrated FIGS. 2 to 6. The base is constructed so that it behaves as a beam with 3 support points having adjustable feet 41 at the apices of the triangular base. Two box tube members 31 and 32 are welded together using the box tube cross members 33, 34 and 35. The box tube members may be in two parts joined by the lower member 40. Preferably the members 31 and 32 are in one piece. The cross members 34 and 35 support the stator column which is held in place by the lower clamp ring 39 on the column support consisting of the vertical web 37 and the pair of rectangular box tubes 38.

The second level of the base consists of the elevated support plates 54 and 55. The plate 55 is supported by trusses composed of angled box tubes 52 and vertical box tubes 52A extending inwardly and upwardly from the free ends of the frame members 31 and 32. The vertical box tubes 52 are welded to the cross members 35 and plate 55 is supported at its other end by the top edge of the web 37. The support plate 54 is supported by a truss composed of an angled box tube 51 and vertical box tube 51A extending rearwardly and upwardly from the junction of the base frame box tubes 31 and 32. The vertical box tube 51A is secured to cross member 33 and at its other end plate 54 is supported by the leading edge of the support plate 55. Instead of two plates 54 and 55 a single plate may be used.

The column 61 is stabilized by a second clamp ring which is fastened to the plate 55. The rotatable part of column 61 with the indexing arm 56 is rotated by the chain drive indexing system by way of crank arm 62. Electric motor 63 drives the crank arm 62 of the indexing mechanism. In FIGS. 5 and 6 an alternative pneumatic actuator 74 and crank arm 72 is shown. The carousel supporting the pallet arms is lifted by the cylinders 58 located in the space between the upper plate 55 and the cross members 34 and 35.

The base is lighter and more maneuverable than prior art bases. With 3 adjustable feet 41 instead of four it is easier to obtain a stable installation on uneven floor surfaces. The strength of the base is contributed by the height of the plate 54/55 above the base 31/32 because the structure allows it to act as a beam and the strength of the beam increases with its thickness.

From the above those skilled in the art will realize that the present invention provides an inexpensive and easy to build base that provides added rigidity and stability to screen printing machines. Those skilled in the art will realize that this invention may be utilized in a number of embodiments other than those described, without departing from the core teaching of this invention.

1. A carousel screen printing machine which includes
a) a stator supporting a plurality of print heads
b) a rotor supporting a plurality of pallet support arms
c) said rotor being mounted for rotation about said stator
d) drive means for said rotor
e) a base for said stator consisting of
i) base frame members secured together to form a first platform
ii) the first platform having three support feet
iii) an elevated platform supported by frame members mounted on said first platform
iv) the stator being mounted on a frame member in the first platform and extending vertically through the elevated platform
v) the rotor being mounted on said elevated platform
vi) at least part of the drive means being located on said first platform.

2. A carousel screen printing machine as claimed in claim 1 in which the drive means is an electric motor mounted on the first platform and an indexing chain drive mounted on the elevated platform said chain drive being rotated by the electric motor to rotate the rotor.

3. A carousel screen printing machine as claimed in claim 1 in which the
i) first platform consists of two base frame members joined at one end and extending away from each other at an acute angle with cross members extending between said base frame members
ii) the elevated platform is supported by members extending from the junction of the base frame members and from adjacent the free ends of the base frame members

4. A carousel screen printing machine which includes
a) stationary column supporting a plurality of print heads
b) a rotatable carousel mounted on said column supporting a plurality of pallet support arms
c) drive means for indexed movement of said carousel about said column
d) a base for said column consisting of
i) two base frame members joined at one end and extending away from each other at an acute angle
iii) cross members extending between said base frame members
iv) an elevated platform supported by a member extending from the junction of the base frame members and from adjacent the free ends of the base frame members
v) a stationary column support located on at least one cross member and arranged so that the column extends through the elevated platform
vi) at least part of the drive means for the rotatable column being located below the support platform.

5. A carousel screen printing machine as claimed in claim 4 in which the drive means is an electric motor mounted on the base and an indexing chain drive mounted on the elevated platform said chain drive being rotated by the electric motor to rotate the rotor.
